(19) United States
(12) Patent Application Publication
(10) Pub. No.: US 2014/0067243 A1
(43) Pub. Date: Mar. 6, 2014

(54) CENTRALIZED ROUTE DETERMINATION

(71) Applicants: Karsten Muehlmann, Stuttgart (DE); Daniel Withopf, Stuttgart (DE); Florian Hauler, Karlsruhe (DE)

(72) Inventors: Karsten Muehlmann, Stuttgart (DE); Daniel Withopf, Stuttgart (DE); Florian Hauler, Karlsruhe (DE)

(73) Assignee: ROBERT BOSCH GMBH, Stuttgart (DE)

(21) Appl. No.: 13/964,723

(22) Filed: Aug. 12, 2013

(30) Foreign Application Priority Data
Aug. 31, 2012 (DE) 10 2012 215 447.7

(51) Int. Cl. G01C 21/34

(52) U.S. Cl. CPC G01C 21/3492
USPC 701/117; 701/537

(57) ABSTRACT

A method for route guidance of a user includes steps of transmitting a first item of information with respect to a planned journey from an instantaneous position to a destination position from the user to a central authority, determining, by way of the central authority, a traffic situation in an area of a route from the instantaneous position to the destination position, and transmitting a second item of information, which provides information about the traffic situation, from the central authority to the user.

### FIELD OF THE INVENTION

The present invention relates to route determination for a user. In particular, the present invention relates to route guidance of a motor vehicle from an instantaneous position to a destination position with the aid of a centralized service.

### BACKGROUND

Navigation systems are known in the related art. For example, it is routine to provide a satellite-assisted navigation system on board a motor vehicle. The navigation system is configured for the purpose of determining an instantaneous position and determining a route to the destination based on locally available map information and carrying out route guidance to the destination. In order to take into consideration an instantaneous traffic situation on the route between the instantaneous position and the destination, traffic information may be centrally determined and transmitted via Very High Frequency (VHF), for example. The navigation system may include an appropriately prepared receiver and may determine so-called Traffic Message Channel (TMC) information from signals received therewith, which gives information about traffic disruptions, for example. The determination of the route may then be carried out in consideration of the traffic disruptions.

The refresh rate of such TMC information is routinely low, however. In addition, the TMC format does not permit the transmission of more detailed information. Finally, the bandwidth of the medium used is so low that only traffic disruptions or imminent disruptions are transmitted, but not a traffic occurrence or a traffic throughput on a section, for example.

So-called off board navigation systems use a central authority, to which a user transmits the user's instantaneous and destination positions, upon which a route is determined by the central authority and transmitted back to the user. Technical requirements for a navigation device of the user may thus be low.

### SUMMARY

An object of the present invention is to provide an improved method for route guidance of a user. Example embodiments of the present invention provide a method and/or computer program product for achieving this objective.

A method according to an example embodiment of the present invention for route guidance of a user, for example who is on board a motor vehicle, includes steps of transmitting a first item of information with respect to a planned journey from an instantaneous position to a destination position from the user to a central authority, determining, by the central authority, a traffic situation in the area of a route from the instantaneous position to the destination position, and transmitting a second item of information which provides information about the traffic situation from the central authority to the user.

Due to the consideration of the traffic situation by the central authority, it is possible in an improved manner to use instantaneous, detailed information of high spatial resolution for the determination of an optimum route. The determined route may therefore bring the user more rapidly, cost-effectively, and/or via a shorter path to the predetermined destination.

According to an example embodiment of the present invention, off boar navigation is provided in which the first item of information includes the instantaneous position and the destination position of the user, the route is determined on the part of the central authority, and the second item of information includes the route. This embodiment allows the use of the navigation method with only little technical means. For example, a corresponding high-performance processing device does not have to be provided to the user to carry out the route determination. Also, updates, for example, of the map data used for the processing device, need not be carried out on the part of the user.

According to an alternative example embodiment, the route is determined on the user-side and the first item of information includes the determined route. In this way, a majority of the required effort for determining the route may already be carried out on the user-side. Improvement or alteration of the route may then be carried out on the part of the central authority. The route guidance may also remain functional in the event of an interrupted connection between the user and the central authority. A computing load on the part of the central authority may thus be reduced, whereby load peaks and waiting times resulting therefrom may be reduced. In an example embodiment of this variant, the second item of information includes a route which is changed based on the traffic situation. The amended route may only differ in small details from the route initially determined on the user side, so that, for example, the route guidance of the user may already be begun before the checking of the determined route has been carried out by the central authority and transmitted back to the user.

In an example embodiment, the central authority is configured for the purpose of controlling a device for influencing a traffic stream, in particular of motor vehicle traffic, based on a plurality of first items of information. The first items of information preferably originate from different users. The more users participate in the described navigation service, the more information about the intentions of travelers is provided on the part of the central authority. In particular, the present information may relate to a future traffic development. It is thus possible to control a device for influencing a traffic stream, for example, a traffic signal, a barrier, a variable speed limit, or a dynamic traffic lane controller. The traffic flow in the area of controlled sections may thus be improved for multiple traffic participants.

In an example embodiment, the central authority is configured for the purpose of determining the second item of information based on a plurality of first items of information of multiple users in such a way that the users are essentially equally distributed onto equivalent sections. In other words, the information provided on the part of the central authority about the travel plans of users may be used for the purpose of straightening out the routes of the participating users. Alternatively usable portions or equivalent sections of the road network may thus be loaded uniformly. The traffic flow on the mentioned sections may thus be optimized.

In an example embodiment, a unique identifier is assigned to the user and the identifier is transmitted together with the first item of information. A user may thus be identified in the event of repeated transmission of a first item of information to the central authority. The route guidance and in particular the separation of routes of multiple users may thus be implementable in an improved manner.

In an example embodiment, the central authority determines the traffic situation based on historic traffic data. The historic traffic data may in particular include a previous day, a corresponding day of the previous week, the previous month, or the previous year, or a statistical processing of historic data. In particular the processing may be carried out in such a way that a future traffic situation is determined based on the historic traffic data. The future traffic situation may be determined in particular with respect to predicted whereabouts of the user. The traffic occurrence, which will result in the area of the user during the user's travel along the route to the destination position, may thus be taken into consideration in improved approximation.

The central authority preferably determines the traffic situation based on data of a traffic monitoring system. Thus, in particular, partially processed or unprocessed measured values of the traffic monitoring system may be used to avoid information losses, for example, by summary or averaging.

In an example embodiment of the method, a second item of information is transmitted from the user to a further user. If the users are located on board motor vehicles, the transmission may be carried out with the aid of car-to-car infrastructure (C2C). If the further user does not have communication means to the central authority, the further user may nonetheless profit from information about a traffic situation in the surroundings of the first user. Since the further user is located in the area of the first user during the transmission of the second item of information, the transmitted information may also be relevant for the further user or the further user's route planning.

Example embodiments of the present invention provide a computer program product, e.g., including a computer-readable data carrier, that includes program code executable on a processing device for carrying out the described methods.

### BRIEF DESCRIPTION OF THE DRAWINGS

FIG. 1 shows a system for the navigation of users, according to an example embodiment of the present invention.

FIG. 2 is a flowchart of a method for the navigation of a user, according to an example embodiment of the present invention.

### DETAILED DESCRIPTION

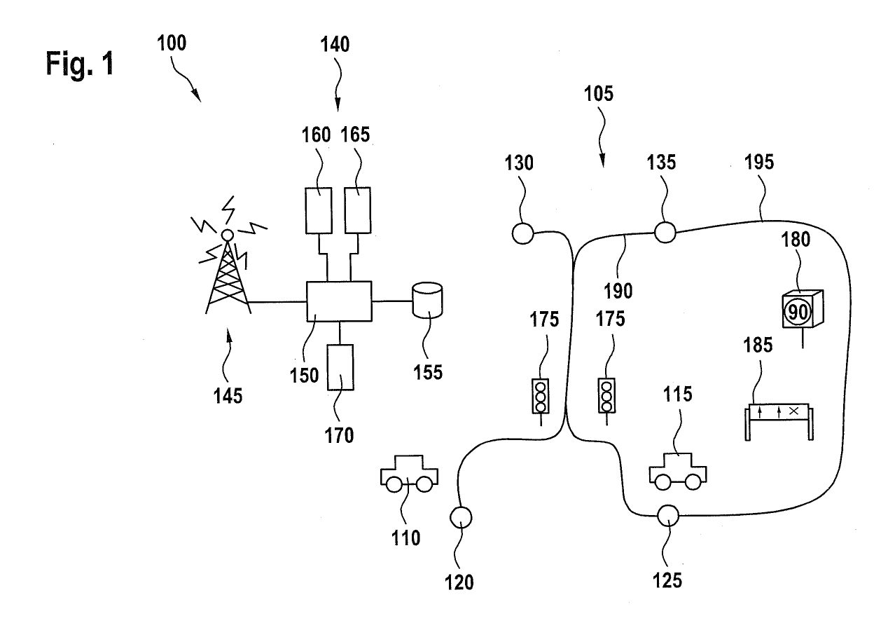

FIG. 1 shows a system 100 for the navigation of users, according to an example embodiment of the present invention. Although system 100 is suited for the purpose of being used by users using any desired transport means, system 100 is described hereafter with respect to an example referring to motor vehicles, the users being represented by motor vehicles.

In FIG. 1, a first motor vehicle 110 and a second motor vehicle 115 are located on a road network 105 as examples. First motor vehicle 110 is located at a first instantaneous position 120, and second motor vehicle 115 is located at a second instantaneous position 125. In the illustrated example, first vehicle 110 is to be guided to a first destination position 130 and second motor vehicle 115 is to be guided to a second destination position 135.

A data link exists, at least temporarily, between a central authority 140 and each of motor vehicles 110 and 115. For this purpose, motor vehicles 110, 115 are provided with wireless transmission devices (not shown), and central authority 140 includes a corresponding, preferably wireless, transmission device 145. Furthermore, central authority 140 includes a processing device 150, which is connected to transmission device 145 and also preferably to at least one of a memory 155 for recording map data, a traffic monitoring system 160 for determining traffic parameters on road network 105, a disruption determination system 165 for determining messages about traffic disruptions on road network 105, and a traffic influencing device 170.

The memory includes cartographic data of road network 105, secondary information such as a traffic classification of a portion, a traffic regulation, or topographic information also being able to be included. In one example embodiment, memory 155 is also configured for storing historic traffic information. This traffic information may include, for example, disruption messages of disruption determination system 165 or traffic data, in particular driving speeds or degrees of utilization of sections of road network 105. Disruption determination system 165 may collect information which is provided, for example, by the police, emergency services, or a traffic jam warning service. Processing device 150 may be configured for the purpose of accessing the historic information and preparing it appropriately, in particular by selection and summary. An instantaneous or future traffic situation of a portion of road network 105 may thus be interpolated or extrapolated from the historic data.

Traffic influencing device 170 may control, for example, a traffic signal 175, a dynamic speed limiter 180, or a dynamic lane assignment unit 185. In an example embodiment, central authority 140 is formed in a so-called cloud. A physical location of elements 145 through 170 of central authority 140 may thus be secondary, although authority 140 remains central in a logical respect.

Motor vehicles 110 and 115 are configured for the purpose of transmitting a first item of information with respect to their journeys from instantaneous positions 120 or 125 to destination positions 130 or 135, respectively, to central authority 140 and to receive a second item of information from central authority 140, which provides information about a traffic situation which prevails on their particular routes. Central authority 140 may carry out the determination or improvement of the particular route based on the first item of information and a plurality of further items of information. In one preferred example embodiment, information about further motor vehicles is taken into consideration, whose routes are known at a predetermined point in time on the part of central authority 140.

In an example embodiment, a separation of the traffic on road network 105 may be carried out by a routing of second motor vehicle 115 to include a second section 195 instead first section 190 if it is known that first motor vehicle 110 will use a portion of first section 190. In particular, if a higher proportion of motor vehicles traveling on road network 105 synchronize their planned routes with central authority 140, the routes may be influenced by central authority 140 in such a way that road network 105 has little disruption or is free of disruption in an improved way. The freedom from disruption may be perceptible to both individual motor vehicles 110, 115 and also to further traffic participants.

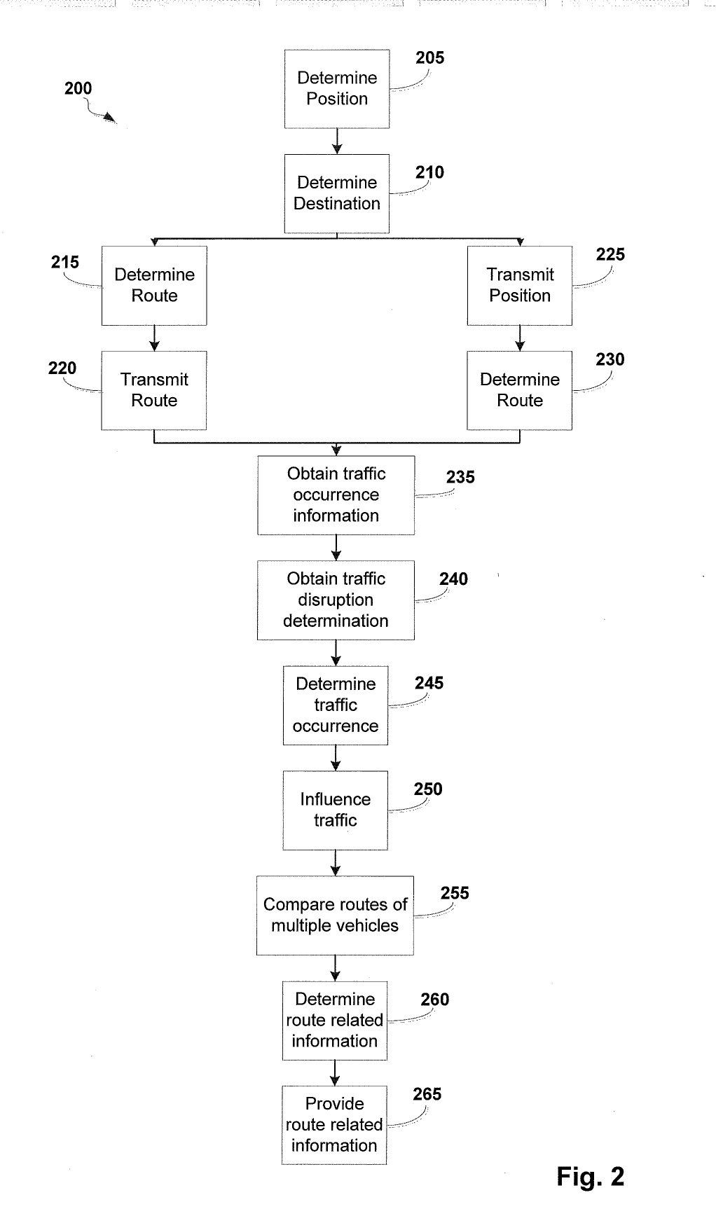

FIG. 2 is a flowchart of a method 200 for the navigation of a motor vehicle 110, 115 on a road network 105, for example, using the system of FIG. 1, according to an example embodiment of the present invention. Parts of method 200 are carried out on the part of a user, i.e., with reference to FIG. 1 on board a motor vehicle 110 or 115, while other parts are carried out on the part of central authority 140. Method 200 is explained hereafter as an example by way of first motor vehicle 110 as a user.

In a first step 205, its instantaneous position 120 is determined on the part of motor vehicle 110. This determination may be carried out, for example, by sampling an input of a person or by measuring, for example, with the aid of a satellite navigation system. In yet another example embodiment, position 120 may also be determined based on a GSM radio cell.

In a step 210, which may alternatively also be carried out before step 205, destination position 130 of motor vehicle 110 is determined. This determination is typically carried out with the cooperation of user-input by a person on board motor vehicle 110.

In a first variant of present method 200, subsequently, in a step 215, a route is determined from instantaneous position 120 to destination position 130 on the part of motor vehicle 110. For this purpose, motor vehicle 110 is provided with a processing device communicatively coupled to a memory that includes map data of road network 105, and the route is determined based on the map data. In a following step 220, the determined route is transmitted to central authority 140. In one example embodiment, multiple alternative routes may also be determined and transmitted to central authority 140. A unique identifier assigned to first motor vehicle 110 is preferably also transmitted to central authority 140, to be able to correctly assign later queries of first motor vehicle 110.

In a second variant of method 200, the route is not determined on the part of motor vehicle 110. Instead, in a step 225, position 120 and destination position 130 are transmitted to central authority 140 and the route is subsequently determined in a step 230 on the part of central authority 140. The route determination is carried out here with the aid of processing device 150 and based on the map data of memory 155. In this variant, the identifier assigned to first motor vehicle 110 may also be transmitted to make a later reference by central authority 140 easier.

In both variants, information about a traffic occurrence on road network 105 is determined or received, for example, via traffic monitoring system 160, in a step 235 on the part of the central authority.

In a step 240, warnings about traffic disruptions are determined or received, in particular via disruption determination system 165, by central authority 140.

In a step 245, a traffic occurrence in road network 105 is determined based on historic data in memory 155. The determination may relate to the instantaneous point in time or a future point in time. The future point in time preferably includes a travel time of motor vehicle 110 on road network 105. In one variant, historic data about a first portion of road network 105 may also be used or transmitted to determine the traffic occurrence on a second portion.

In a step 250, central authority 140 influences, for example, with the aid of traffic influencing device 170, control elements for controlling the traffic on road network 105. The control may be carried out in particular based on known planned routes of a plurality of motor vehicles. For example, if it is known that many motor vehicles will travel a first section 190, an access to section 190 may be regulated accordingly with the aid of traffic signal 175 to avoid a traffic overload of section 190. Alternatively, the traffic on road network 105 may also be influenced, for example, by transmitting a speed to be maintained to motor vehicle 110 or to multiple motor vehicles.

In one particularly preferred example embodiment, in a step 255, known routes of further motor vehicles are compared or correlated with the determined route of motor vehicle 110. In one example embodiment, this relates to routes which have already been determined on the part of central authority 140, but have not yet been transmitted to the further motor vehicles.

Some or all of the information of steps 235 to 255 is used in a following step 260 to determine a route or suggestions for changing the route of first motor vehicle 110.

In the case of the above-described first variant, which includes steps 215 and 220 and in which the route was already determined on the part of motor vehicle 110, information for changing the route may be provided in step 260. This information may include in particular portions of road network 105 which are difficult to travel and are therefore to be avoided. The information may, vice versa, also include portions of the road network which are particularly good to travel and are therefore to be preferred. Final route planning may be performed later on the part of motor vehicle 110, by changing or not changing the route previously determined therein based on the information provided in step 260, either automatically or interactively with a driver of first motor vehicle 110. In the case of the above-described second variant, which includes steps 225 and 230 and in which the route of motor vehicle 110 remains to be determined on the part of central authority 140, the route determination is updated in this step.

The determination is carried out in both variants in particular in consideration of routes of further motor vehicles, which have transmitted their travel information to central authority 140. A type of social network for route planning therefore exists, the network including motor vehicles 110 and 115. The route of motor vehicle 110 may be changed simultaneously with the route of another motor vehicle 115, so that motor vehicles 110, 115 use different sections 190, 195, for example. In another example embodiment, the routes or the suggestions for route change may be determined in such a way that a highly loaded area or an area susceptible to disruptions of road network 105 is traveled less.

For example, if first section 190 is to be relieved, for example, because first motor vehicle 110 may not use any section other than the first section on its journey, it may thus be advisable to determine the route of second motor vehicle 115 in such a way that it includes second section 195 instead of first section 190. The selection of alternative section 195 suggests itself in particular if sections 190 and 195 are at least approximately equivalent with respect to their lengths or the travel times to be expected thereon, for example. In one example embodiment, it may also be accepted that second section 195 is longer by a predetermined amount than first section 190 or may be traveled with a prolonged travel time.

The determined route or the suggestions for changing the already determined route are provided in step 260 as a second item of information.

Of steps 235 through 250, those whose information is not incorporated in the provision of the second item of information may be omitted. Furthermore, the sequence of steps 235 through 250 may also be changed. In particular, some of steps 235 through 250 may already be carried out at a point in time at which a first item of information in the form of the route or positions 120, 130 of first motor vehicle 110 have not yet arrived at central authority 140.

In a final step 265, the second item of information is transmitted from central authority 140 to motor vehicle 110. Motor vehicle 110 is made capable by the second item of information of determining a route from its instantaneous position 120 to destination position 130 on road network 105 in an improved way or to travel an improved route.

In one variant of method 200, parts of the second item of information may also be transmitted from first motor vehicle 110 to second motor vehicle 115, in order to allow second motor vehicle 115 to bypass sections 190 which are difficult to travel, for example. The communication between motor vehicles 110 and 115 may be carried out in any arbitrary way, for example, with the aid of car-to-car communication, if motor vehicles 110, 115 are within a predetermined distance from one another. Due to the boundary condition of the limited distance, a second item of information of first motor vehicle 110 may be relevant for second motor vehicle 115, since it is located at a distance from first motor vehicle 110 which is not excessively great.

What is claimed is:

1. A computer-implemented route guidance method comprising:
obtaining, by a computer processor of a central processing device and from a user device, a first item of information with respect to a planned journey from an instantaneous position to a destination position;
determining, by the processor, a traffic situation in an area of a first route from the instantaneous position to the destination position;
transmitting, by the processor and to the user device, a second item of information, the second item of information being based on the determined traffic situation.

2. The method of claim 1, wherein the first item of information includes the instantaneous position and the destination position, the first route is determined by the processor, and the second item of information includes the first route.

3. The method of claim 1, wherein the first item of information includes the first route.

4. The method of claim 1, wherein the second item of information includes a modified route that differs from the first route based on the traffic situation.

5. The method of claim 1, wherein the processor is configured to:
receive the first item of information from each of a plurality of user devices, each of the first items of information being with respect to a respective planned journey from a respective instantaneous position to a respective destination position; and
control a device for influencing a traffic flow based on the first items of information from the plurality of user devices.

6. The method of claim 1, wherein the processor is configured to:
receive the first item of information from each of a plurality of user devices, each of the first items of information being with respect to a respective planned journey from a respective instantaneous position to a respective destination position; and
determine the second item of information for each of the user devices based on the first items of information from the plurality of user devices, the second items of information varying for different ones of the user devices to equalize a distribution of routing of the user onto different routes.

7. The method of claim 1, wherein a unique identifier is assigned to the user device and the identifier is obtained by the processor together with the first item of information.

8. The method of claim 1, wherein the traffic situation is determined based on historic traffic data.

9. The method of claim 1, wherein the traffic situation is determined based on data of a traffic monitoring system.

10. The method of claim 1, wherein the second item of information is transmitted from the user device to another user device.

11. The method of claim 1, wherein the user device is a component of a first vehicle.

12. The method of claim 11, wherein the second item of information is transmitted from the user device to another user which is a component of a second vehicle.

13. The method of claim 1, wherein the user device is a component of a first vehicle, the processor is accessible by the user device and by user devices that are respective components of other respective vehicles.

14. The method of claim 13, wherein the second item of information is based on respective route related information of the first vehicle and of the other respective vehicles.

15. A non-transitory computer-readable medium on which are stored instructions executable by a processor, the instructions which, when executed by the processor, cause the processor to perform a route guidance method, the method comprising:
obtaining from a user device a first item of information with respect to a planned journey from an instantaneous position to a destination position;
determining a traffic situation in an area of a first route from the instantaneous position to the destination position; and
transmitting to the user device a second item of information, the second item of information being based on the determined traffic situation.
